(19) United States
(12) Patent Application Publication
(10) Pub. No.: US 2009/0315502 A1
(43) Pub. Date: Dec. 24, 2009

(54) ACCELERATION AND DECELERATION CONTROL APPARATUS AND METHOD THEREOF

(75) Inventors: YUEH-HSUN KING, Tu-Cheng (TW); JHY-HAU CHIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/329,612

(22) Filed: Dec. 7, 2008

(30) Foreign Application Priority Data
Jun. 20, 2008 (CN) 200810302262.8

(51) Int. Cl. G05B 19/25

(52) U.S. Cl. 318/573

(57) ABSTRACT

An acceleration/deceleration control apparatus for a computer numerical control machine tool includes an interpolator, a motion-transforming unit, and a drive transforming unit. The interpolator receives a velocity signal and outputs a pulse velocity signal. The motion unit is connected to the interpolator and includes an operation filter. The operation filter includes a plurality of different weight values and a plurality of registers corresponding to the numbers of the weights to calculate the pulse velocity signal to an acceleration/deceleration pulse velocity signal by a first function. The weight values are derived by a second function corresponding to the shape of the acceleration/deceleration pulse velocity signal. The driving unit is connected to the motion unit and transforms the acceleration/deceleration pulse velocity signal to a driving signal to drive a motor.

### BACKGROUND

1. Field of the Disclosure

The disclosure relates to servo control in numerical control (NC) machine tools and, specifically, to an acceleration/deceleration servo control apparatus in NC machine tools, industrial robots, and others.

2. Description of Related Art

Computer numerical control (CNC) machines are generally driven for a required operation by means of a servo circuit for each axle which responds to a command applied through an interpolation circuit.

In these CNC machines, the servomotor is liable to produce vibration when the value of the command changes considerably, for example, when the servomotor is started or stopped. Conventionally, vibration is restrained by an acceleration/deceleration control system which receives the command from the interpolator and executes an acceleration/deceleration operation for the received command with the resultant velocity achieved after the acceleration/deceleration process. The acceleration/deceleration operation process utilizes a moving average method, altering the trapezoidal curve of the velocity pulse signal to the bell curve of the velocity pulse signal. The bell curve of the velocity pulse signal is smoother than the trapezoidal curve of the velocity pulse signal. FIG. 8 shows the CNC machine 1, which includes an input unit 11, a motion-transforming unit 12, and a driving unit 13. The input unit 11 receives a velocity signal D1 which is transformed to a velocity pulse signal D2, as shown in FIG. 9. The motion-transforming unit 12 connected to the input unit 11 and the driving unit 13. The motion-transforming unit 12 includes a first filter 121, a second filter 122, and a third filter 123 connected in series. The first, second and third filters 121, 122 and 123 are finite impulse response (FIR) filters, each including n weights K0-Kn-1 and n registers R0-Rn-1, as shown in FIG. 10. The weights K0-Kn-1 and the registers R0-Rn-1 correspond respectively. The value of velocity pulse signals D2 is stored in the registers R0-Rn-1 and multiplied by the corresponding value of the weights K0-Kn-1. Consequently, the first filter 121 adds the values obtained by the multiplication operation, and multiplies the resultant sum by 1/n, thereby outputting a first velocity pulse signal V1 to the second filter 122. The second and third filters 122 and 123 are constructed in the same manner as the first filter 121, and hence illustrations and explanations thereof are omitted herefrom.

First filter 121, second filter 122, and third filter 123 differ in that first filter 121 receives the velocity pulse signal D2 and outputs the first velocity pulse signal V1; the second filter 122 receives the first velocity pulse signal V1 and outputs the second velocity pulse signal V2; and the third filter 123 receives the second velocity pulse signal V2 and outputs the acceleration/deceleration pulse signal D3 to the driving unit 13, as shown in FIG. 11.

The moving average method modifies the square curve of the velocity pulse signal D2 output from the input unit 11 to the bell curve of the acceleration/deceleration pulse signal D3. The first filter 121 receives the velocity pulse signal D2 and, multiplied by the corresponding value of the weights K0-Kn-1 at one sampling time T, add, and multiply the resultant sum by a value “1/n” and output a first velocity pulse signal V1 to the second filter 122. The second filter 122 and the third filter 123 use the same moving average method to obtain the second velocity pulse signal V2 (the B curve shown in FIG. 12) and an acceleration/deceleration pulse signal D3 (the C curve shown in FIG. 12) respectively. Three applications of the moving average method change the velocity pulse signal D2 to the acceleration/deceleration pulse signal D3.

As shown in FIG. 12 and FIG. 13, using one moving average method delays the signal for the one acceleration/deceleration process time Tn. Curves A, B, and C are obtained by the first, second and third moving average methods respectively. The curve of the acceleration/deceleration pulse signal D3 is obtained using the moving average method three times. The moving average method provides only one parameter to set the acceleration/deceleration time and still allows the angle and the peak E of the curve.

What is needed, therefore, is an acceleration/deceleration control method addressing the limitations described.

### BRIEF DESCRIPTION OF THE DRAWINGS

FIG. 1 is a block diagram showing an acceleration/deceleration control apparatus according to an embodiment of the disclosure.

FIG. 2 is a block diagram of a motion-transforming unit of the acceleration/deceleration control apparatus shown in FIG. 1.

FIG. 3 is a graph of the velocity pulse received by the motion-transforming unit of the acceleration/deceleration control apparatus shown in FIG. 1.

FIG. 4 is a graph of the acceleration/deceleration pulse outputted by the motion-transforming unit of the acceleration/deceleration control apparatus shown in FIG 1.

FIG. 5 is a graph of the second function of the acceleration/deceleration control apparatus of FIG. 1 according to the present disclosure.

FIG. 6 is a graph of acceleration of the acceleration/deceleration control apparatus of FIG. 1 according to the present disclosure.

FIG. 7 is a graph showing the sudden change of the acceleration/deceleration control apparatus of FIG. 1 according to the present disclosure.

FIG. 8 is a schematic block diagram showing a related art acceleration/deceleration control apparatus.

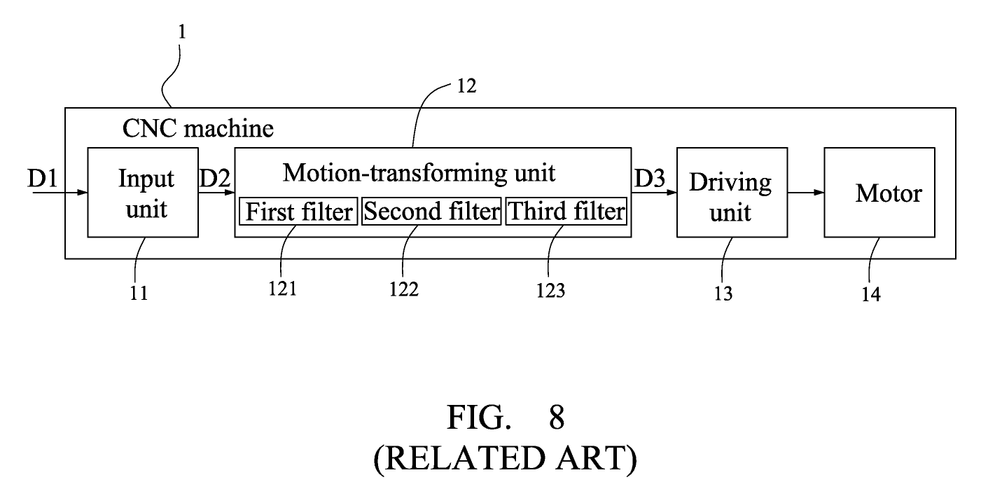

FIG. 9 is a graph of velocity pulse signal through the input unit shown in FIG 8.

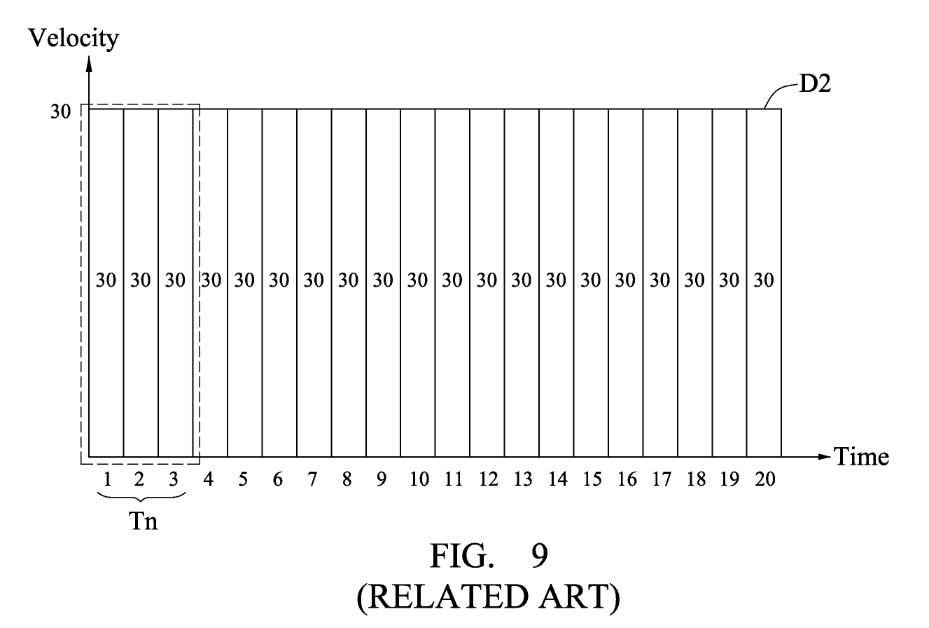

FIG. 10 is a block diagram of the motion-transforming unit shown in FIG. 8.

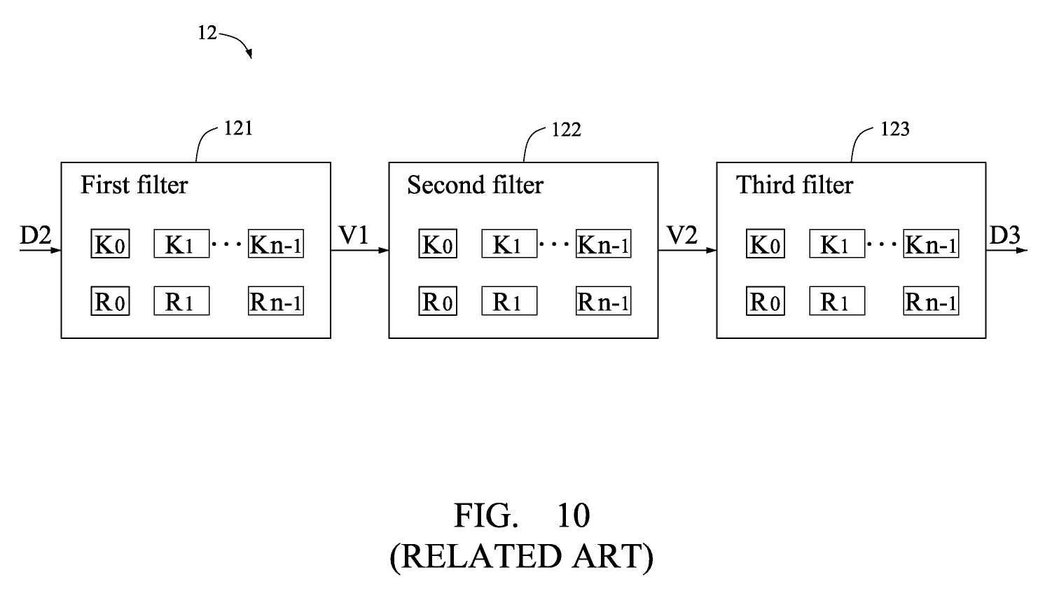

FIG. 11 is a graph of an acceleration/deceleration pulse signal output from the acceleration/deceleration control apparatus shown in FIG. 8.

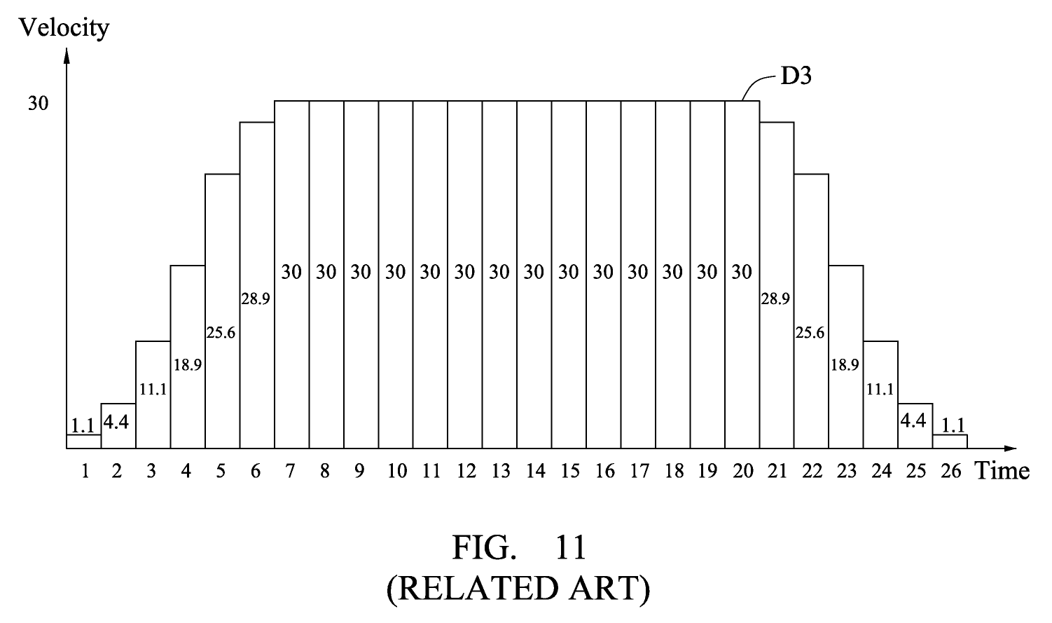

FIG. 12 is a graph of the acceleration/deceleration pulse signal output from the first, second and third filters, respectively, shown in FIG. 8.

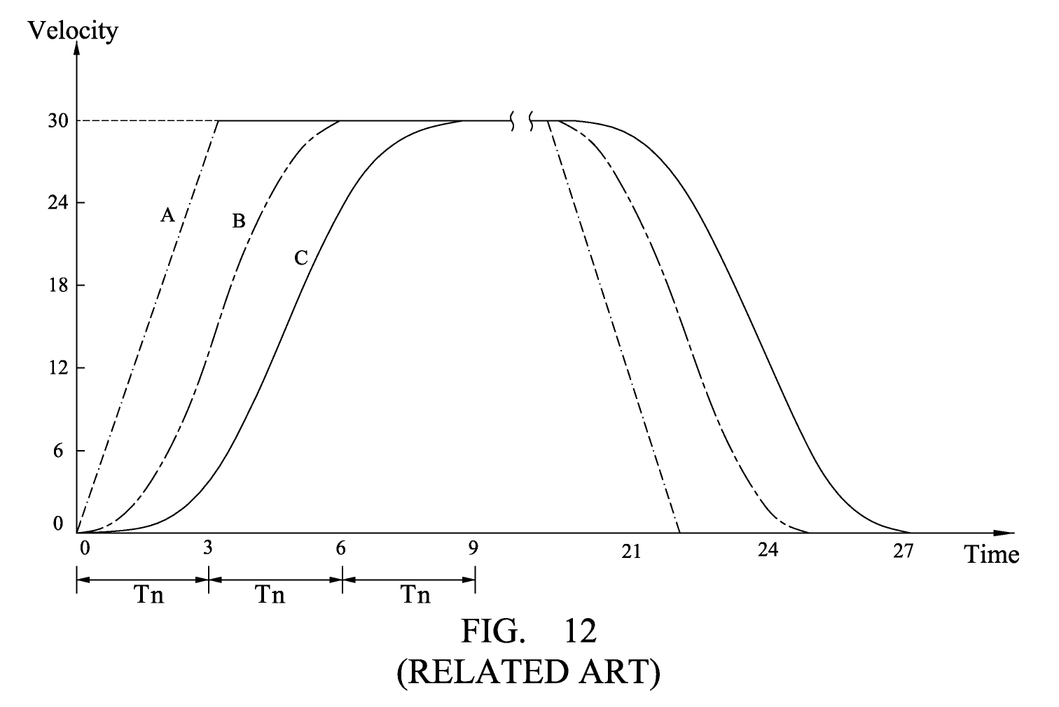

FIG. 13 is a graph of sudden change profile of an acceleration/deceleration control apparatus shown in FIG. 8.

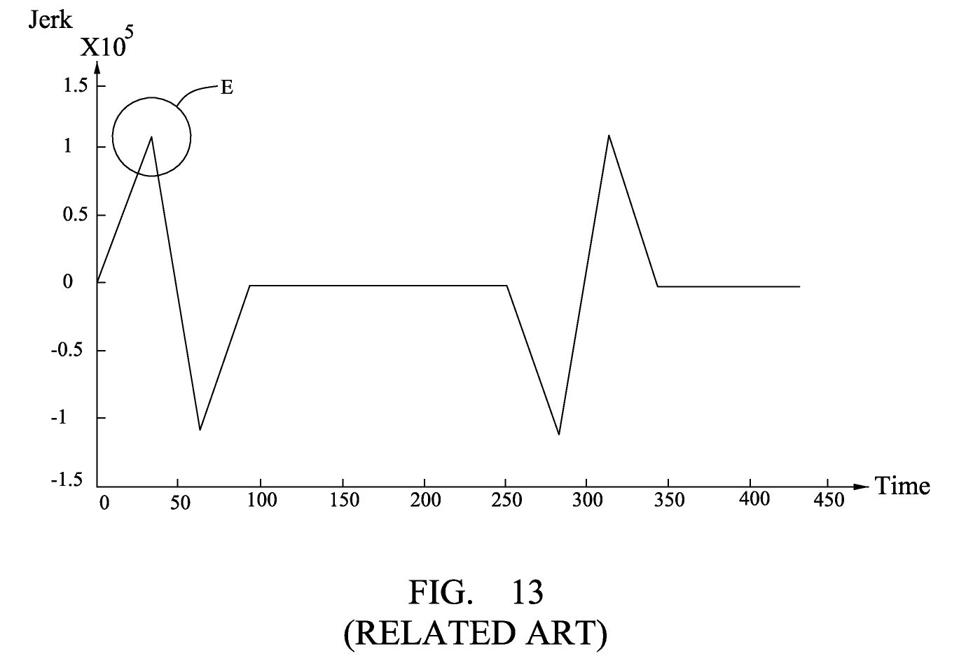

### DETAILED DESCRIPTION

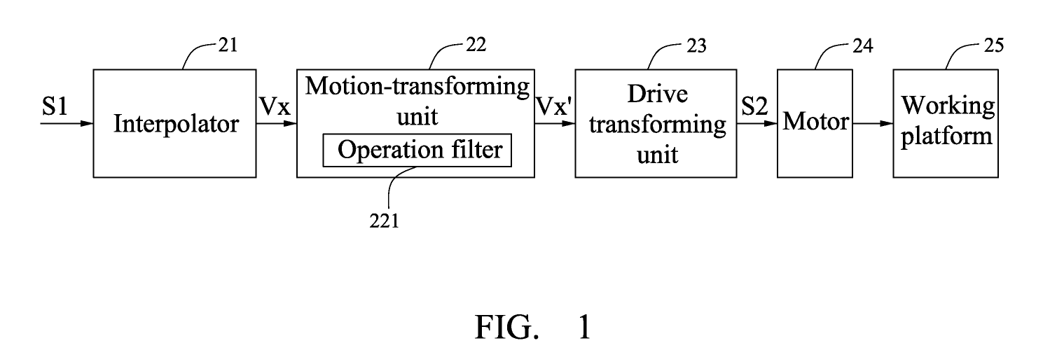

FIG. 1 shows an acceleration/deceleration control apparatus according to an embodiment of the disclosure, providing servo control in a CNC machine. The acceleration/deceleration control apparatus includes an interpolator 21, a motion-transforming unit 22, a drive transforming unit 23, and a motor 24 for driving a tool or a working platform 25.

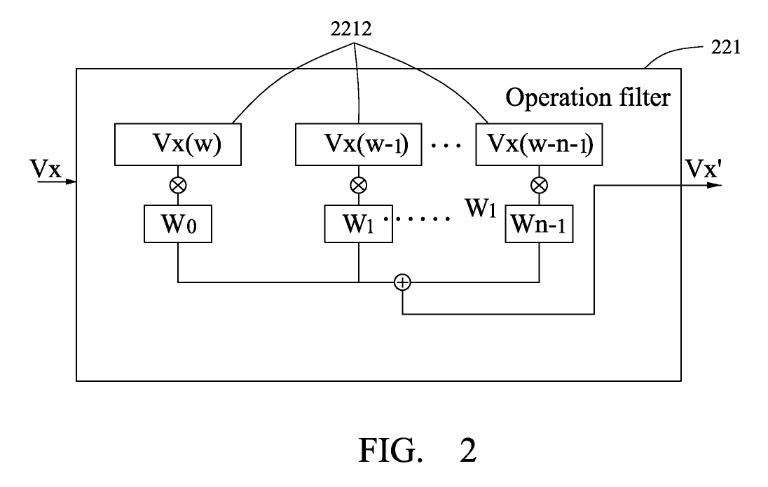

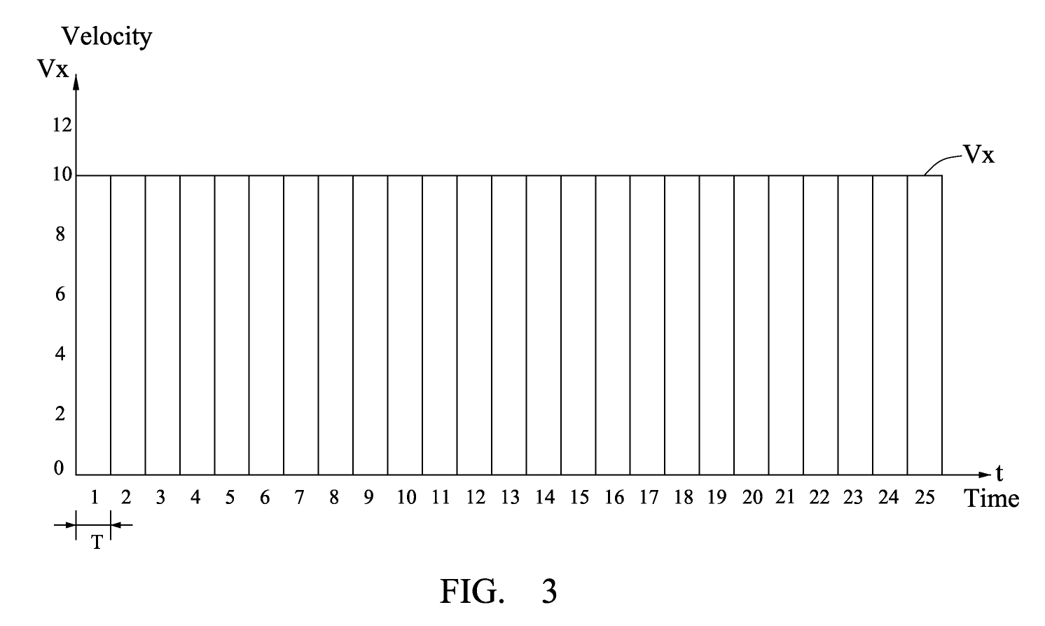

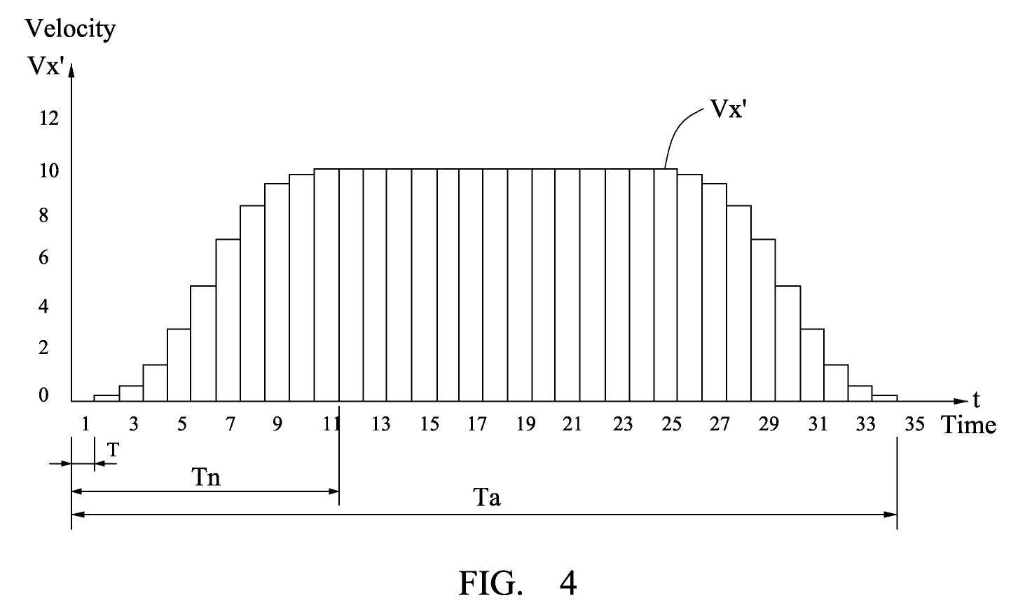

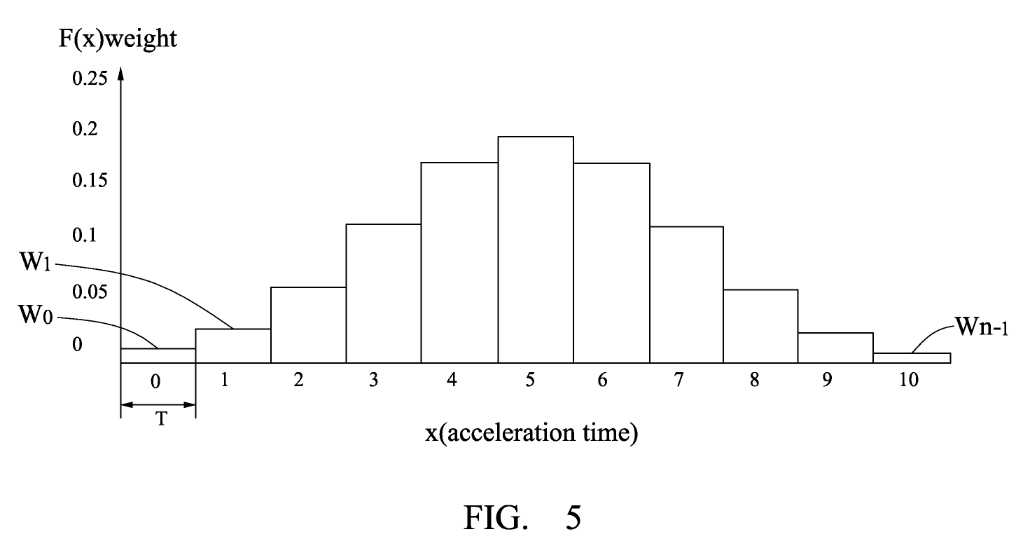

The interpolator 21 receives a velocity command S1 and outputs a velocity pulse Vx, as shown in FIG. 3, to a motion-transforming unit 22. The motion-transforming unit 22 includes an operation filter 221 which receives the velocity pulse Vx supplied from the interpolator 21 and outputs an acceleration/deceleration pulse signal V′x. As shown in FIG. 2, the operation filter 221 includes a plurality of registers 2212 and uses a plurality of different values of weight ω₀, ω₁ . . . ωₙ₋₁ corresponding to the registers 2212. The operation filter 221 outputs an acceleration/deceleration pulse signal V′x calculated by the subsequent first function formula, as shown in FIG. 4. The weight values ω₀, ω₁ . . . ωₙ₋₁ are given by the second function formula ƒ(n) at an interval of predetermined period Tn. The first function formula is:

$${V}^{′} x [ ω ] = {\sum }_{i = o}^{n - 1} \{ \frac{f ( i )}{Ks} \times Vx [ ω - i ] \}$$

where V′x[ω] is an acceleration/deceleration pulse signal calculated by the first function formula, Vx[ω−i] is the velocity pulse signal corresponding to the weights, ƒ(i) is the value of the weight ω₀, ω₁ . . . ωₙ₋₁, Ks is the sum of ƒ(i), and n is the number of the registers 2212. The second function ƒ(n) corresponds to the shape of the acceleration/deceleration pulse signal V′x. As shown in FIG. 5, the second function can be Gaussian function, extreme value distribution function or other function representing a shape corresponding to the acceleration/deceleration pulse signal V′x. The Gaussian function operation is

$$f ( n ) = \frac{1}{σ \sqrt{2 π}} {e}^{- \frac{{( n - μ )}^{2}}{2 {σ}^{2}}}$$

where σ is standard deviation, μ is expectation value, n is the number of the registers, the weights ω₀, ω₁ . . . ωₙ₋₁ given by the Gaussian function at n number of sampling period T. As also shown in FIG. 1, the drive transforming unit 23 transforms the acceleration/deceleration pulse signal V′x to a driving signal S2 to control the rotational speed and direction of the motor 24. The driving signal S2 can be a pulse or a voltage.

As illustrated in FIG. 5, when n is 11, standard deviation σ is 2, expectation value μ is 5, at 11 sampling times, the 11 number of weight values ω₀, ω₁ . . . ω₁₀ are given by the second function ƒ(n) (Gaussian Function). Three values of weight show ω₀, ω₅ and ω₁₀, where ω₀ and ω₁₀ are 0.00876415, ω₅ is 0.199477114.

As shown in FIG. 4, a total acceleration/deceleration process time Ta is divided into 35 samples period T. The operation filter 221 substitutes Vx and ω₀, ω₁ . . . ω₁₀ into the first function and outputs an acceleration/deceleration pulse signal V′x. The graph of the acceleration/deceleration pulse signal V′x is a smooth curve. Here, different parameters (e.g., σ and μ) will have different process of the acceleration/deceleration control, effectively improving precision and quality of the processing of the CNC machine.

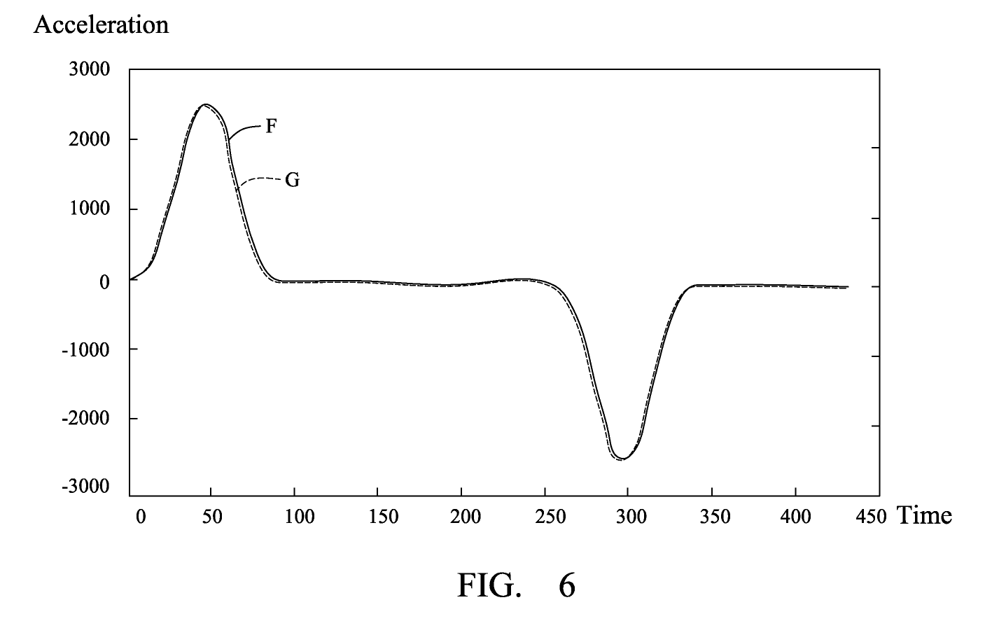

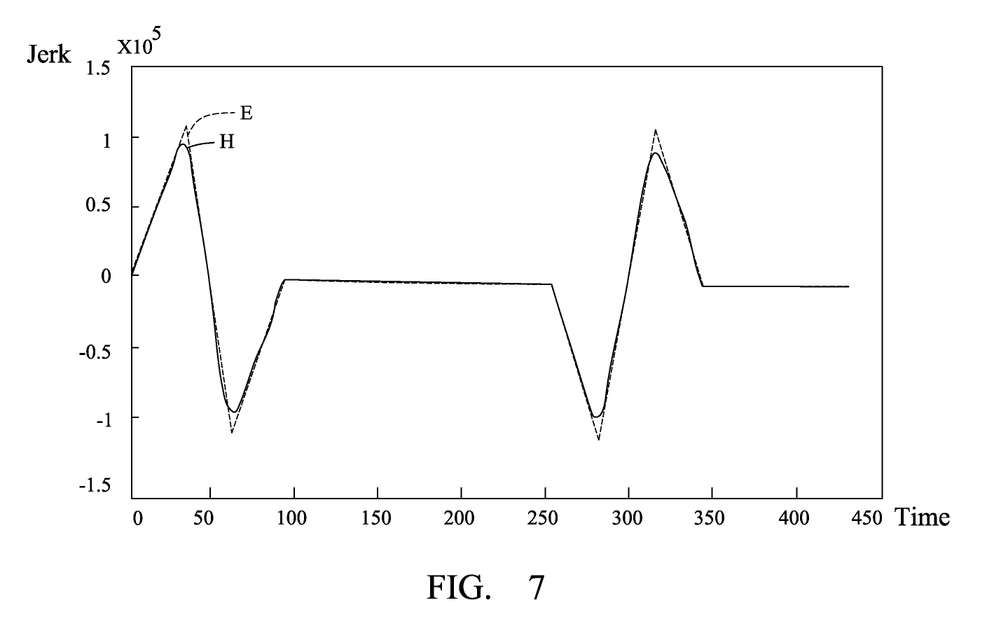

Also as shown in FIGS. 6 and 7, the operation filter 221 receives the velocity pulse signal Vx and executes acceleration/deceleration operations to obtain the curve F of the acceleration/deceleration pulse signal V′x. The shape of the curve F is same as curve G of the acceleration/deceleration pulse signal V′x obtained by three operations of the moving average method, as shown in FIG. 6. The peak H of the graph of sudden change is smoother than the peak E of the graph of the sudden change three operations of the moving average method, as shown in FIG. 7.

According to the method disclosed, only one acceleration/deceleration process is required to achieve a smooth curve, securely restraining vibration of servomotors.

It is understood that the disclosure may be embodied in other forms without departing from the spirit thereof. Thus, the present example and embodiment is to be considered in all respects as illustrative and not restrictive, and the disclosure is not to be limited to the details given herein.

What is claimed is:

1. An acceleration/deceleration control apparatus for servo control of a computer numerical control (CNC) machine, the apparatus comprising:
an interpolator configured for receiving a velocity signal and outputting a velocity pulse signal;
a motion-transforming unit connected to the interpolator and configured for receiving the velocity pulse signal, the motion-transforming unit comprising an operation filter, the operation filter comprising a plurality of registers and using a plurality of weight values corresponding to the registers, and configured for obtaining an acceleration/deceleration pulse signal according to a first function;
a drive transforming unit connected to the motion-transforming unit and configured for transforming the acceleration/deceleration pulse signal to a driving signal.

2. The acceleration/deceleration control apparatus as claimed in claim 1, wherein the first function is
$${V}^{′} x [ ω ] = {\sum }_{i = o}^{n - 1} \{ \frac{f ( i )}{Ks} \times Vx [ ω - i ] \}$$
wherein V′x[ω] is an acceleration/deceleration pulse signal, Vx[ω−i] is a velocity pulse signal corresponding to the weights, ƒ(i) is the value of the weight, Ks is the sum of ƒ(i), and n is the number of registers.

3. The acceleration/deceleration control apparatus as claimed in claim 1, wherein the weight values are provided by a second, Gaussian function:
$$f ( n ) = \frac{1}{σ \sqrt{2 π}} {e}^{- \frac{{( n - μ )}^{2}}{2 {σ}^{2}}}$$
wherein σ is standard deviation, μ is expectation value, and n is the number of sampling periods T.

4. The acceleration/deceleration control apparatus as claimed in claim 1, wherein the weight values are given by an extreme value distribution function corresponding to the shape of the acceleration/deceleration pulse signal,

5. The acceleration/deceleration control apparatus as claimed in claim 1, wherein the driving signal is a pulse or voltage.

6. An acceleration/deceleration control method for servo control of a CNC machine, the method comprising:
providing an interpolator for receiving a velocity signal and outputting a velocity pulse signal;
receiving the velocity pulse signal, and calculating an acceleration/deceleration pulse signal by a first function, based on receiving the velocity pulse signal, using a motion-transforming unit connected to the interpolator, the motion-transforming unit comprising an operation filter comprising a plurality of registers and using a plurality of weight values corresponding to the registers,
receiving the acceleration/deceleration pulse signal and obtaining a driving signal transformed by a drive transforming unit, based on the acceleration/deceleration pulse signal, to drive a motor, the drive transforming unit connected to the motion-transforming unit.

7. The acceleration/deceleration control method as claimed in claim 6, wherein the first function formula is
$${V}^{′} x [ ω ] = {\sum }_{i = o}^{n - 1} \{ \frac{f ( i )}{Ks} \times Vx [ ω - i ] \}$$
wherein V′x[ω] is an acceleration/deceleration pulse signal, Vx[ω−i] is a pulse velocity signal corresponding to the weight values, ƒ(i) is the value of the weight, Ks is the sum of ƒ(i), and n is the number of registers.

8. The acceleration/deceleration control method as claimed in claim 6, wherein the weight values are given by a second function, a Gaussian function of:
$$f ( n ) = \frac{1}{σ \sqrt{2 π}} {e}^{- \frac{{( n - μ )}^{2}}{2 {σ}^{2}}}$$
wherein σ is a standard deviation, μ is an expectation value, and n is the number of sampling periods T.

9. The acceleration/deceleration control method as claimed in claim 6, wherein the weight values are given by a second function which is an extreme value distribution function corresponding to the acceleration/deceleration pulse signal.

10. The acceleration/deceleration control method as claimed in claim 6, wherein the drive transforming unit transforms the driving signal to a pulse or a voltage.
